(19) United States
(12) Patent Application Publication
(10) Pub. No.: US 2024/0036402 A1
(43) Pub. Date: Feb. 1, 2024

(54) DISPLAY PANEL, MANUFACTURING METHOD THEREOF, AND DISPLAY DEVICE

(71) Applicant: TCL China Star Optoelectronics Technology Co., Ltd., Shenzhen (CN)

(72) Inventor: Mingyao WANG, Shenzhen (CN)

(21) Appl. No.: 17/430,076

(22) PCT Filed: Jul. 9, 2021
(86) PCT No.: PCT/CN2021/105381

§ 371 Date: Aug. 11, 2021

(30) Foreign Application Priority Data
Jun. 11, 2021 (CN) 202110653399.3

(51) Int. Cl. G02F 1/1339; G02F 1/1335

(52) U.S. Cl. CPC G02F 1/13394; G02F 1/13396; G02F 1/133512

(57) ABSTRACT

The present application discloses a display panel, a manufacturing method thereof, and a display device. The display panel includes a first substrate and a second substrate disposed oppositely, and a liquid crystal layer and a spacer layer disposed between the first substrate and the second substrate. The spacer layer includes a main spacer column and a sub-spacer column. A thickness of the main spacer column is equal to a thickness of the sub-spacer column. An aperture is defined in the first substrate or the second substrate and corresponds to the sub-spacer column.

### FIELD OF INVENTION

The present application relates to a field of display, especially to a display panel, a manufacturing method thereof, and a display device.

### BACKGROUND OF INVENTION

A main body structure of a liquid crystal display device is a liquid crystal display panel. During manufacturing processes of a liquid crystal display panel, designs of cell thickness and pressure-resistance are one of key technologies of the liquid crystal display device and directly affects a quality of the liquid crystal display device. When the liquid crystal display panel is in a low temperature state, liquid crystals shrink, and vacuum bubbles appear. When the liquid crystal display panel is in a high temperature state, the liquid crystals expand due to heat, which would easily cause the liquid crystals inside the display panel to flow down as a whole and result in uneven gravity.

At present, to solve the above problems, the conventional technology usually uses a main spacer and auxiliary spacers with different heights to ensure a uniform cell thickness to meet a filling range of the liquid crystals. However, in such solution, when manufacturing the main spacer and auxiliary spacers, it is necessary to perform processes such as coating, exposure, development, and peeling twice respectively to obtain spacers with two film thicknesses, such that the process of the liquid crystal display panel is more complicated and costly.

### SUMMARY OF INVENTION

### Technical Issue

The embodiment of the present application provides a display panel, a manufacturing method thereof, and a display device to efficiently reduce a manufacturing cost of the display panel.

### Technical Solution

To achieve the above functions, the embodiment of the present application provides technical solutions as follows.

A display panel, comprises a first substrate and second substrate disposed oppositely and a liquid crystal layer and a spacer layer disposed between the first substrate and the second substrate, wherein the spacer layer comprises a main spacer column and a sub-spacer column disposed between the first substrate and the second substrate;
wherein a thickness of the main spacer column is equal to a thickness of the sub-spacer column; an aperture is defined in the first substrate and corresponds to the sub-spacer column, a distance between the sub-spacer column and the first substrate is greater than a distance between the main spacer column and the first substrate, or an aperture is defined in the second substrate and corresponds to the sub-spacer column, a distance between the sub-spacer column and the second substrate is greater than a distance between the main spacer column and the second substrate.

In the display panel provided by the embodiment of the present application, the main spacer column and the sub-spacer column are disposed on the second substrate; and
the first substrate comprises a first underlay and a color resist layer disposed on a side of the first underlay near the second substrate, the aperture is defined in a portion of the color resist layer corresponding to the sub-spacer column, and the sub-spacer column is disposed in the aperture.

In the display panel provided by the embodiment of the present application, the display panel comprises a display region and a non-display region adjacent to the display region, wherein adjacent ones of the apertures are disposed at intervals and are located in the non-display region.

In the display panel provided by the embodiment of the present application, the color resist layer at least comprises a first color resist, a second color resist, and a third color resist, a thickness of the second color resist is less than a thickness of the first color resist, and a thickness of the third color resist is less than the thickness of the first color resist; and
wherein the main spacer column is disposed to correspond to the first color resist, the sub-spacer column is disposed to correspond to the second color resist and the third color resist, and the aperture is disposed on the second color resist and/or the third color resist.

In the display panel provided by the embodiment of the present application, an orthographic projection of the first color resist on the second substrate covers an orthographic projection of the main spacer column on the second substrate, an orthographic projection of the second color resist and the third color resist on the second substrate covers an orthographic projection of the sub-spacer column on the second substrate, the aperture is defined in the second color resist and/or the third color resist.

In the display panel provided by the embodiment of the present application, the main spacer column and the sub-spacer column are located on the first substrate, the second substrate comprises a second underlay and a black matrix located on a side of the second underlay near the first substrate, and the aperture is disposed on the black matrix and corresponds to the sub-spacer column.

In the display panel provided by the embodiment of the present application, the black matrix comprises a plurality of black modules, the black modules comprise a first black module corresponding to the sub-spacer column, the aperture is defined in the first black module and extends to a periphery of the first black module, and a thickness of each portion of the first black module is the same.

In the display panel provided by the embodiment of the present application, the first substrate comprises a metal layer; and
wherein an orthographic projection of the metal layer on the first substrate covers an orthographic projection of the aperture on the first substrate.

In the display panel provided by the embodiment of the present application, the orthographic projection of the metal layer on the first substrate covers an orthographic projection of the main spacer column on the first substrate, the orthographic projection of the metal layer on the first substrate covers an orthographic projection of the sub-spacer column on the first substrate.

The embodiment of the present application also provides a display panel manufacturing method, comprising steps as follows:
providing a first substrate and a second substrate and defining an aperture in one of the first substrate or the second substrate, wherein a main spacer column and a sub-spacer column with equal thicknesses are formed on the other of the first substrate or the second substrate;
aligning the first substrate with the second substrate such that the sub-spacer column corresponds to the aperture; and
forming a liquid crystal layer between the first substrate and the second substrate.

In the display panel manufacturing method in the embodiment of the present application, the step of providing the first substrate and the second substrate and defining the aperture in one of the first substrate or the second substrate comprises: providing the first substrate and defining the aperture in the first substrate;
the step of providing the first substrate and defining the aperture in the first substrate comprises:
providing a first underlay;
forming a color resist material layer on the first underlay; and
providing a mask, and exposing and developing the color resist material layer to form a color resist layer comprising the aperture, wherein the mask comprises a main light transmission region disposed to correspond to the color resist material layer and a sub-light transmission region located adjacent to the main light transmission region, the sub-light transmission region comprises a plurality of light shielding frames disposed at intervals, and a slit for light transmission is formed between adjacent two of the light shielding frames.

In the display panel manufacturing method in the embodiment of the present application, the step of providing the first substrate and the second substrate and defining the aperture in one of the first substrate or the second substrate comprises: providing the second substrate and defining the aperture in the second substrate;
the step of providing the second substrate and defining the aperture in the second substrate comprises:
providing a second underlay;
forming a black matrix material layer on the second underlay; and
providing a mask, and exposing and developing the black matrix material layer to form a black matrix comprising the aperture, wherein the mask comprises a main light transmission region disposed to correspond to the black matrix material layer and a sub-light transmission region located adjacent to the main light transmission region, the sub-light transmission region comprises a plurality of light shielding frames disposed at intervals, and a slit for light transmission is formed between adjacent two of the light shielding frames.

The embodiment of the present application also provides a display device, comprising a display panel, and the display panel comprising a first substrate and second substrate disposed oppositely and a liquid crystal layer and a spacer layer disposed between the first substrate and the second substrate, wherein the spacer layer comprises a main spacer column and a sub-spacer column disposed between the first substrate and the second substrate;
wherein a thickness of the main spacer column is equal to a thickness of the sub-spacer column; an aperture is defined in the first substrate and corresponds to the sub-spacer column, a distance between the sub-spacer column and the first substrate is greater than a distance between the main spacer column and the first substrate, or an aperture is defined in the second substrate and corresponds to the sub-spacer column, a distance between the sub-spacer column and the second substrate is greater than a distance between the main spacer column and the second substrate.

In the display device provided by the embodiment of the present application, the main spacer column and the sub-spacer column are disposed on the second substrate; and
the first substrate comprises a first underlay and a color resist layer disposed on a side of the first underlay near the second substrate, the aperture is defined in a portion of the color resist layer corresponding to the sub-spacer column, and the sub-spacer column is disposed in the aperture.

In the display device provided by the embodiment of the present application, the display panel comprises a display region and a non-display region adjacent to the display region, wherein adjacent ones of the apertures are disposed at intervals and are located in the non-display region.

In the display device provided by the embodiment of the present application, the color resist layer at least comprises a first color resist, a second color resist, and a third color resist, a thickness of the second color resist is less than a thickness of the first color resist, and a thickness of the third color resist is less than the thickness of the first color resist; and
wherein the main spacer column is disposed to correspond to the first color resist, the sub-spacer column is disposed to correspond to the second color resist and the third color resist, and the aperture is disposed on the second color resist and/or the third color resist.

In the display device provided by the embodiment of the present application, an orthographic projection of the first color resist on the second substrate covers an orthographic projection of the main spacer column on the second substrate, an orthographic projection of the second color resist and the third color resist on the second substrate covers an orthographic projection of the sub-spacer column on the second substrate, the aperture is defined in the second color resist and/or the third color resist.

In the display device provided by the embodiment of the present application, the main spacer column and the sub-spacer column are located on the first substrate, the second substrate comprises a second underlay and a black matrix located on a side of the second underlay near the first substrate, and the aperture is disposed on the black matrix and corresponds to the sub-spacer column.

In the display device provided by the embodiment of the present application, the black matrix comprises a plurality of black modules, the black modules comprise a first black module corresponding to the sub-spacer column, the aperture is defined in the first black module and extends to a periphery of the first black module, and a thickness of each portion of the first black module is the same.

In the display device provided by the embodiment of the present application, the first substrate comprises a metal layer; and
wherein an orthographic projection of the metal layer on the first substrate covers an orthographic projection of the aperture on the first substrate.

### Advantages

A display panel provided by the embodiment of the present application comprises a main spacer column and a sub-spacer column with equal thicknesses so only one kind of spacer columns needs to be manufactured. Namely, to manufacture the main spacer column and the sub-spacer column, only one mask process needs to be implemented, which further lowers a process cost of the display panel.

### DESCRIPTION OF DRAWINGS

Specific embodiments of the present invention are described in details with accompanying drawings as follows to make technical solutions and advantages of the present invention clear.

FIG. 1 is a schematic structural view of a conventional display panel.

FIG. 2 is a first schematic structural view of a display panel provided by an embodiment of the present application.

FIG. 3 is a second schematic structural view of the display panel provided by an embodiment of the present application.

FIG. 4 is a third schematic structural view of the display panel provided by an embodiment of the present application.

FIG. 5 is a fourth schematic structural view of the display panel provided by an embodiment of the present application.

FIG. 6 is a flowchart diagram of a display panel manufacturing method provided by an embodiment of the present application.

FIGS. 7A to 7D are first schematic structural views of manufacturing processes of the display panel provided by the embodiment of the present application.

FIG. 8 is a first top view of a mask provided by an embodiment of the present application.

FIGS. 9A to 9D are second schematic structural views of the display panel provided by the embodiment of the present application.

FIG. 10 is a second top view of the mask provided by the embodiment of the present application.

### DETAILED DESCRIPTION OF PREFERRED EMBODIMENTS

The present application provides a display panel, a manufacturing method thereof, and a display device. To make the objective, the technical solution, and the effect of the present application clearer and more explicit, the present application will be further described in detail below with reference to the accompanying drawings. It should be understood that the specific embodiments described here are only used to explain the present application instead of being used to limit the present application.

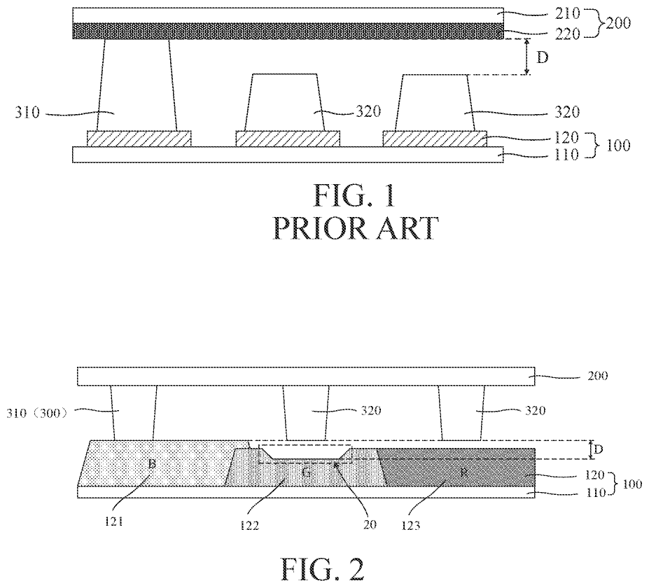

With reference to FIG. 1, FIG. 1 is a schematic structural view of a conventional display panel.

In the conventional technology, a display panel comprises a first substrate 100 and a second substrate 200 disposed oppositely, and a liquid crystal layer (not shown in the figures) disposed between the first substrate 100 and the second substrate 200. A side of the first substrate 100 near the second substrate 200 comprises a first underlay 110 and a color resist layer 120 that are stacked on each other. A side of the second substrate 200 near the first substrate 100 comprises a second underlay 210 and a black matrix 220 that are stacked on each other. To prevent an issue that when the liquid crystal display panel is in a low temperature state, liquid crystals shrink and vacuum bubbles appear, and when the liquid crystal display panel is in a high temperature state, the liquid crystals expand due to heat, which would easily cause the liquid crystals inside the display panel to flow down as a whole and result in uneven gravity, generally a main spacer column 310 and a sub-spacer column 320 having a thickness difference D are disposed between the first substrate 100 and the second substrate 200 to use the thickness difference D between the main spacer column 310 and the sub-spacer column 320 to fulfill a filling range of liquid crystals. However, during manufacturing of the main spacer column 310 and the sub-spacer column 320, half-tone masks (HTMs) with different transmittances or gray-tone masks (GTMs) are required for manufacturing, and a cost of the masks is much higher compared to that of normal masks. Therefore, in the conventional technology, a process cost of the display panel is higher. As such, the embodiment of the present application provides a display panel, a manufacturing method thereof, and a display device for effectively lowering a manufacturing cost of the display panel.

With reference to FIGS. 1 to 5, the embodiment of the present application provides a display panel, the display panel comprises a first substrate 100 and a second substrate 200 disposed oppositely, and a liquid crystal layer (not shown in the figures) and a spacer layer 300 disposed between the first substrate 100 and the second substrate 200. The spacer layer 300 comprises a main spacer column 310 and a sub-spacer column 320 disposed between the first substrate 100 and the second substrate 200.

A thickness of the main spacer column 310 is equal to a thickness of the sub-spacer column 320. An aperture 20 is defined in the first substrate 100 and corresponds to the sub-spacer column 320. A distance between the sub-spacer column 320 and the first substrate 100 is greater than a distance between the main spacer column 310 and the first substrate 100. Alternatively, an aperture 20 is defined in the second substrate 200 and corresponds to the sub-spacer column 320, and a distance between the sub-spacer column 320 and the second substrate 200 is greater than a distance between the main spacer column 310 and the second substrate 200.

A display panel provided by the embodiment of the present application comprises the main spacer column 310 and the sub-spacer column 320 with the equal thickness. Therefore, only spacer columns with one height need to be manufactured. Namely, when the main spacer column 310 and the sub-spacer column 320 are manufactured, a mask process only needs to be implemented once, which further lowers a manufacturing cost of the display panel. At the same time, an aperture 20 is defined in the first substrate 100 or the second substrate 200 and corresponds to the sub-spacer column 320, such that a step difference is formed between the main spacer column 310 and sub-spacer column 320 to fulfill a filling range of liquid crystals.

Specific embodiments are combined to describe the technical solution of the present application.

With reference to FIG. 2, FIG. 2 is a first schematic structural view of a display panel provided by an embodiment of the present application.

The present embodiment provides a display panel, the display panel comprises a first substrate 100 and a second substrate 200 disposed oppositely, and a liquid crystal layer and a spacer layer 300 disposed between the first substrate 100 and the second substrate 200. The spacer layer 300 comprises a main spacer column 310 and a sub-spacer column 320 disposed between the first substrate 100 and the second substrate 200. A thickness of the main spacer column 310 is equal to a thickness of the sub-spacer column 320. An aperture 20 is defined in the first substrate 100 and corresponds to the sub-spacer column 320. A distance between the sub-spacer column 320 and the first substrate 100 is greater than a distance between the main spacer column 310 and the first substrate 100.

It can be understood that in the present embodiment the thickness of the main spacer column 310 is equal to the thickness of the sub-spacer column 320, such that the main spacer column 310 and the sub-spacer column 320 can be manufactured under the same mask process without using another mask process for manufacturing spacer columns with different thickness, which simplifies manufacturing processes of the display panel. At the same time, different from the conventional technologies wherein it is required to use half-tone masks or grayscale masks having different transmittances to manufacture the main spacer column 310 and the sub-spacer column 320 with unequal thicknesses, in the present embodiment, the main spacer column 310 and the sub-spacer column 320 can be manufactured by a general mask, which effectively lowers a manufacturing cost of the display panel.

It should be explained that the first substrate 100 can be one of an array substrate or a color filter substrate, and the second substrate 200 can be the other of the array substrate or the color filter substrate. The present embodiment has no specific limit to the first substrate 100.

In the present embodiment, the main spacer column 310 and the sub-spacer column 320 are disposed on the second substrate 200. The first substrate 100 comprises a first underlay 110 and a color resist layer 120 disposed on a side of the first underlay 110 near the second substrate 200. An aperture 20 is defined in a portion of the color resist layer 120 corresponding to the sub-spacer column 320, and the sub-spacer column 320 is disposed in the aperture 20.

Specifically, the main spacer column 310 is located between the color resist layer 120 and the second substrate 200, an end of the main spacer column 310 is located on the second substrate 200, and another end of the main spacer column 310 abuts the color resist layer 120. The sub-spacer column 320 is located between the aperture 20 of the color resist layer 120 and the second substrate 200, an end of the sub-spacer column 320 is located on the second substrate 200, and another end of the sub-spacer column 320 and the aperture 20 of the color resist layer 120 are disposed at an interval. Clearly, by defining the aperture 20 in the color resist layer 120 to correspond to the sub-spacer column 320, and differentiating the thickness of the color resist layer 120 corresponding to the main spacer column 310 and the sub-spacer column 320 having equal thicknesses, a thickness difference D between the main spacer column 310 and the sub-spacer column 320 is achieved more conveniently to further achieve an effect that the main spacer column 310 contacts and is compressed by the first substrate 100 by a certain degree, and the sub-spacer column 320 is uncompressed in a normal state and performs an auxiliary support function when receiving an external pressure.

Furthermore, In the present embodiment, the display panel comprises a display region (not shown in the figures) and a non-display region (not shown in the figures) adjacent to the display region. The adjacent apertures 20 are defined at intervals in the non-display region.

In the present embodiment, the color resist layer 120 at least comprises a first color resist 121, a second color resist 122, and a third color resist 123. A thickness of the second color resist 122 is less than a thickness of the first color resist 121, and a thickness of the third color resist 123 is less than a thickness of the first color resist 121. The main spacer column 310 is disposed to correspond to the first color resist 121, the sub-spacer column 320 is disposed to correspond to the second color resist 122 and the third color resist 123, and the aperture 20 is defined in the second color resist 122 and/or the third color resist 123.

Specifically, an orthographic projection of the first color resist 121 on the second substrate 200 covers an orthographic projection of the main spacer column 310 on the second substrate 200. An orthographic projection of the second color resist 122 and the third color resist 123 on the second substrate 200 covers an orthographic projection of the sub-spacer column 320 on the second substrate 200. The aperture 20 is defined in the second color resist 122. It should be explained that the aperture 20 defined in the second color resist 122 is only exemplary for explanation, and the present embodiment has no specific limit thereto.

It can be understood that in the present embodiment, the orthographic projection of the second color resist 122 and the third color resist 123 on the second substrate 200 covers the orthographic projection of the sub-spacer column 320 on the second substrate 200. The aperture 20 is defined in the second color resist 122 and/or the third color resist 123 to lower a height of the sub-spacer column 320 as a whole, such that a thickness of a portion of the first color resist 121 corresponding to the main spacer column 310 is greater than a thickness of the second color resist 122 and a thickness of the third color resist 123, which specifically achieves the thickness difference D between the main spacer column 310 and the sub-spacer column 320.

Specifically, In the present embodiment, the first color resist is a blue color resist, and the second color resist 122 and the third color resist 123 are any combination of green color resist and red color resist. Furthermore, the second color resist 122 is a green color resist, and the third color resist 123 is a red color resist. In the color resist layer 120, the aperture 20 of the green color resist and the aperture 20 of the red color resist correspond to the sub-spacer column 320. The blue color resist corresponds to the main spacer column 310. It can be understood that in a conventional manufacturing process of color resists, according to different optical characteristics of different light colors, during the manufacturing process, a height of the blue color resist is greater than a height of the green color resist or red color resist. Furthermore, the aperture 20 is defined in the green color resist and the red color resist, such that the blue color resist, the green color resist, and the red color resist have greater height difference, which achieves an effect that a thickness difference D exists between the main spacer column 310 and the sub-spacer column 320.

It can be understood that the first color resist 121 is a blue color resist, the second color resist 122 is green color resist, and the third color resist 123 is a red color resist, which are only exemplary for explanation, and the present embodiment has no specific limit thereto.

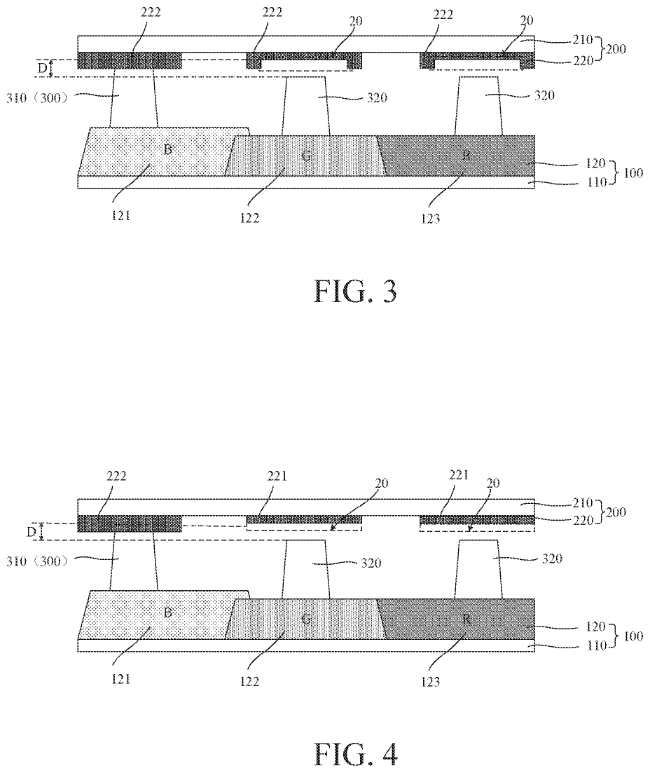

With reference to FIG. 3, FIG. 3 is a second schematic structural view of a display panel provided by an embodiment of the present application.

In the present embodiment, a structure of the display panel is similar to or the same as the first structure of the display panel provided by the above embodiment. For details, please refer to the description of the display panel of the above embodiment, which is not described repeatedly here. A difference between the display panels is as follows.

In the present embodiment, an aperture 20 is defined in the second substrate 200 and corresponds to the sub-spacer column 320. A distance between the sub-spacer column 320 and the second substrate 200 is greater than a distance between the main spacer column 310 and the second substrate 200.

In the present embodiment, both the main spacer column 310 and the sub-spacer column 320 are located on the first substrate 100, and the second substrate 200 comprises a second underlay 210 and a black matrix 220 located on a side of the second underlay 210 near the first substrate 100. The aperture 20 is defined in the black matrix 220 and corresponds to the sub-spacer column 320.

Specifically, the main spacer column 310 is located between the black matrix 220 and the first substrate 100. An end of the main spacer column 310 is located on the first substrate 100, and another end of the main spacer column 310 abuts the black matrix 220. The sub-spacer column 320 is located between the aperture 20 of the black matrix 220 and the first substrate 100. An end of the sub-spacer column 320 is located on the first substrate 100, and another end of the sub-spacer column 320 and the aperture 20 of the black matrix 220 are disposed at an interval. Clearly, by defining the aperture 20 in the black matrix 220 to correspond to the sub-spacer column 320 and differentiating the thickness of the black matrix 220 corresponding to the main spacer column 310 and the sub-spacer column 320 having equal thicknesses, the thickness difference D between the main spacer column 310 and the sub-spacer column 320 is achieved more conveniently to further achieve an effect that the main spacer column 310 contacts and is compressed by the second substrate 200 by a certain degree, and the sub-spacer column 320 is uncompressed in a normal state and performs an auxiliary support function when receiving an external pressure.

Furthermore, with reference to FIG. 4, FIG. 4 is a third schematic structural view of the display panel provided by an embodiment of the present application.

In the present embodiment, the black matrix 220 comprises a plurality of black modules, the black modules comprise a first black module 221 corresponding to the sub-spacer column 320. The aperture 20 is defined in the first black module 221 and extends to a periphery of the first black module 221. A thickness of each portion of the first black module 221 is equal.

Specifically, the black modules further comprise a second black module 222 corresponding to the main spacer column 310. The main spacer column 310 is located between the second black module 222 and the first substrate 100. An end of the main spacer column 310 is located on the first substrate 100, and another end of the main spacer column 310 abuts the second black module 222. The sub-spacer column 320 is located between the first black module 221 and the first substrate 100. An end of the sub-spacer column 320 is located on the first substrate 100, and a gap is defined between another end of the sub-spacer column 320 and the first black module 221. By the aperture 20 being defined in the first black module 221 and extending to the periphery of the first black module 221, the thickness of each portion of the first black module 221 is equal to further specifically achieve the thickness difference D between the main spacer column 310 and the sub-spacer column 320, such that the main spacer column 310 contacts and is compressed by the second substrate 200 by a certain degree, and the sub-spacer column 320 is uncompressed in a normal state and performs an auxiliary support function when receiving an external pressure.

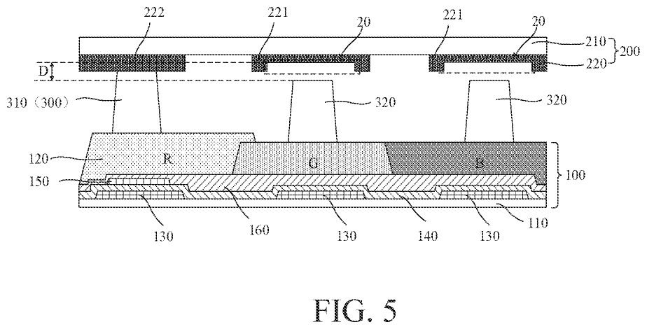

With reference to FIG. 5, FIG. 5 is a fourth schematic structural view of the display panel provided by an embodiment of the present application.

In the present embodiment, a structure of the display panel is similar to or the same as the second structure of the display panel provided by the above embodiment. For details, please refer to the description of the display panel of the above embodiment, which is not described repeatedly here. A difference between the display panels is as follows.

In the present embodiment, the first substrate 100 comprises a metal layer 130. An orthographic projection of the metal layer 130 on the first substrate 100 covers an orthographic projection of the aperture 20 on the first substrate 100.

Specifically, In the present embodiment, the first substrate 100 comprises the first underlay 110, a metal layer 130 located on a side of the first underlay 110 near the second substrate 200, an insulation layer 140 disposed on the metal layer 130 and the first underlay 110 and covering the metal layer 130, an active layer 150 disposed on the insulation layer 140, an interlayer insulation layer 160 disposed on the active layer 150, and the color resist layer 120 disposed on the interlayer insulation layer 160. The metal layer 130 comprises but is not limited to a gate electrode and gate electrode wires connected to the gate electrode.

It should be explained that in the present embodiment, the first underlay 110 can comprise a rigid underlay or a flexible underlay. When the first underlay 110 is a rigid underlay, material can be metal or glass. When the first underlay 110 is a flexible underlay, material can comprise at least one of acrylic resin, methacrylic resin, polyisoprene, vinyl resin, epoxy-based resin, polyurethane-based resin, cellulose resin, silicone resin, polyimide-based resin, or polyamide-based resin. The present embodiment has no limit to the material of the first underlay 110.

In the present embodiment, material of the metal layer 130 can comprise at least one of molybdenum (Mo), aluminum (Al), platinum (Pt), palladium (Pd), silver (Ag), magnesium (Mg), gold (Au), nickel (Ni), neodymium (Nd), iridium (Ir), chromium (Cr), calcium (Ca), titanium (Ti), Tantalum (Ta), or Tungsten (W). Material of the insulation layer 140 comprises but is not limited to silicon oxide.

In the present embodiment, the color resist layer 120 at least comprises a first color resist 121, a second color resist 122, and a third color resist 123. A thickness of the second color resist 122 is less than a thickness of the first color resist 121, and a thickness of the third color resist 123 is less than the thickness of the first color resist 121. An orthographic projection of the first color resist 121 on the second substrate 200 covers an orthographic projection of the main spacer column 310 on the second substrate 200. An orthographic projection of the second color resist 122 and the third color resist 123 on the second substrate 200 covers an orthographic projection of the sub-spacer column 320 on the second substrate 200.

In the present embodiment, an orthographic projection of the metal layer 130 on the first substrate 100 covers an orthographic projection of the aperture 20 on the first substrate 100, the orthographic projection of the metal layer 130 on the first substrate 100 covers an orthographic projection of the sub-spacer column 320 on the first substrate 100. Furthermore, the orthographic projection of the metal layer 130 on the first substrate 100 covers an orthographic projection of the main spacer column 310 on the first substrate 100. Namely, the main spacer column 310 and the sub-spacer column 320 correspond to the metal layer 130.

It should be explained that the first substrate 100 comprises the first underlay 110, the metal layer 130 located on a side of the first underlay 110 near the second substrate 200, an insulation layer 140 disposed on the metal layer 130 and the first underlay 110 and covering the metal layer 130, an active layer 150 disposed on the insulation layer 140, an interlayer insulation layer 160 disposed on the active layer 150, and the color resist layer 120 disposed on the interlayer insulation layer 160. The above descriptions are only exemplary for explanation, and the present embodiment has no limit thereto.

It can be understood that in the present embodiment, by defining the aperture 20 in the black matrix 220 to correspond to the sub-spacer column 320 and differentiating the thickness of the black matrix 220 corresponding to the main spacer column 310 and the sub-spacer column 320 having equal thicknesses, the thickness difference D between the main spacer column 310 and the sub-spacer column 320 is achieved more conveniently to further achieve an effect that the main spacer column 310 contacts and is compressed by the second substrate 200 by a certain degree, and the sub-spacer column 320 is uncompressed in a normal state and performs an auxiliary support function when receiving an external pressure. At the same time, the orthographic projection of the metal layer 130 on the first substrate 100 covers the orthographic projection of the aperture 20 on the first substrate 100 to prevent the thickness of the black matrix 220 corresponding to the aperture 20 from decreasing, influencing a light shielding effect of the black matrix 220, and further influencing a display effect of the display panel.

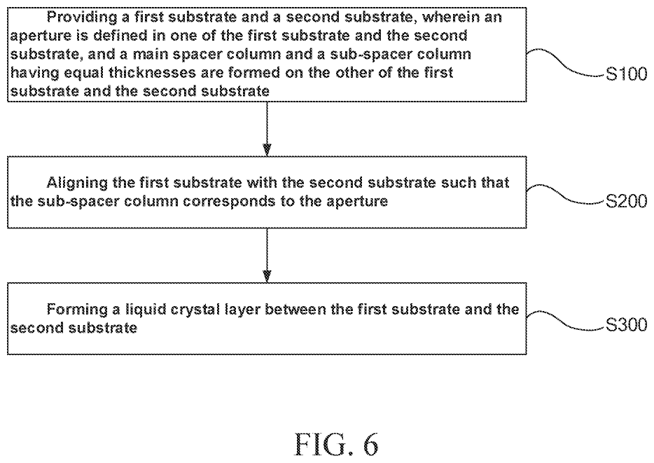

With reference to FIG. 6, FIG. 6 is a flowchart diagram of a display panel manufacturing method provided by an embodiment of the present application.

The embodiment of the present application further provides a display panel manufacturing method, comprising steps as follows.

A step S100 comprising: providing a first substrate 100 and a second substrate 200. An aperture 20 is defined in one of the first substrate 100 or the second substrate 200, and a main spacer column 310 and a sub-spacer column 320 having equal thicknesses are formed on the other of the first substrate 100 or the second substrate 200.

It should be explained that the first substrate 100 can be one of an array substrate or a color filter substrate, and the second substrate 200 can be the other of the array substrate or the color filter substrate, and the present embodiment has no specific limit thereto.

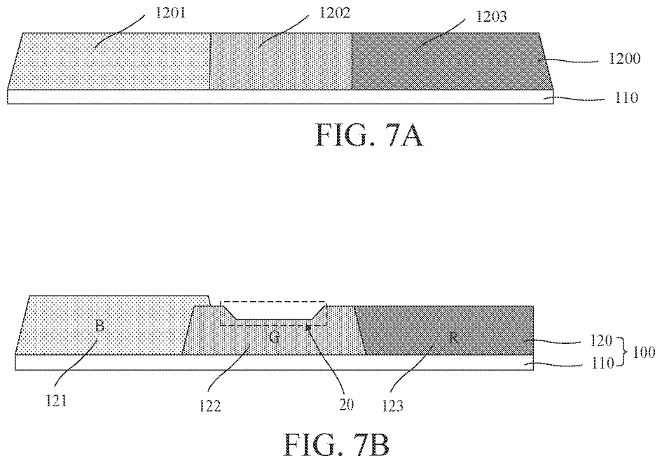

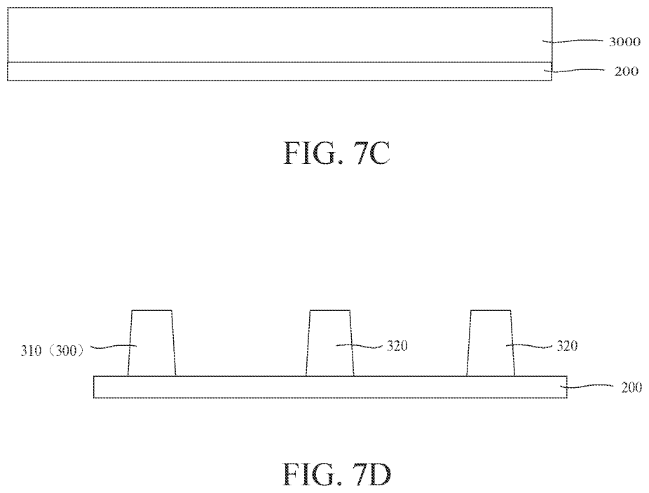

With reference to FIGS. 7A to 7D, in an embodiment, the step S100 comprises steps as follows.

A step S110A comprising: providing a first substrate 100, and forming an aperture 20 on the first substrate 100.

In the present embodiment, the step S110A comprises steps as follows:

A step S111A comprising: providing a first underlay 110.

A step S112A comprising: forming a color resist material layer 1200 on the first underlay 110, as shown in FIG. 7A.

Furthermore, the step S112A comprises: coating color resist material on the first underlay 110. The color resist material at least comprises blue color resist material 1201, green color resist material 1202, and red color resist material 1203. Of course, color resist material of other color can be added according to actual needs, or color resist material of other color can be used to partially or completely replace the above color resist material. Color resist material of other color can be white color resist material. The step S112A comprises curing the color resist material and forming a color resist material layer 1200. The present embodiment has no specific limit to a method for curing the color resist material.

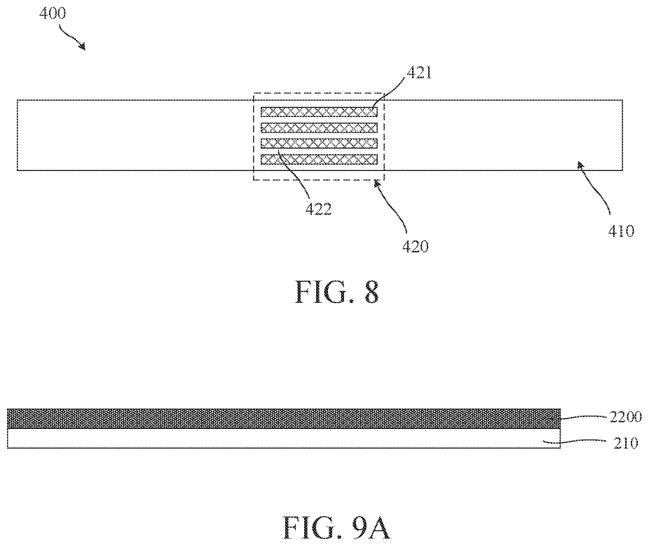

With reference to FIG. 8, a step S113A comprises: providing a mask 400, exposing and developing the color resist material layer 1200, and forming a color resist layer 120 comprising the aperture 20. The mask 400 comprises a main light transmission region 410 disposed to correspond to the color resist material layer 1200 and a sub-light transmission region 420 located adjacent to the main light transmission region 410. The sub-light transmission region 420 comprises a plurality of light shielding frames 421 disposed at intervals, and a light transmission slit 422 is defined between adjacent two of the light shielding frames 421. Preferably, shapes of the main light transmission region 410 and the light shielding frames 421 are rectangular. It can be understood that the present embodiment can adjust an interference degree of light irradiating the sub-light transmission region 420 by adjusting a width and a number of the slits 422 in the sub-light transmission region 420 and an interval between adjacent two of the slits 422 to control an exposure degree of a position of the color resist material layer 120 corresponding to the sub-light transmission region 420.

The present embodiment makes a thickness of a portion of the exposed color resist material layer 1200 corresponding to the main light transmission region 410 greater than a thickness of a portion of the color resist material layer 1200 corresponding to the sub-light transmission region 420 by setting an exposure intensity of the sub-light transmission region 420 to be less than an exposure intensity of the main light transmission region 410. By utilizing a leveling property of the color resist material, an aperture 20 with high surface flatness can be formed in the portion of the color resist material layer 1200 corresponding to the sub-light transmission region 420.

In the present embodiment, the color resist layer 120 at least comprises a first color resist 121, a second color resist 122, and a third color resist 123. A thickness of the second color resist 122 is less than a thickness of the first color resist 121, and a thickness of the third color resist 123 is less than the thickness of the first color resist 121. The aperture 20 is defined in the second color resist 122 and/or the third color resist 123. Furthermore, the aperture 20 is defined in the second color resist 122, as shown in FIG. 7B.

It should be explained that the aperture 20 defined in the second color resist 122 is only exemplary for explanation, and the present embodiment has no limit thereto.

Continuing from the above, step S120A: providing a second substrate 200 and forming a main spacer column 310 and a sub-spacer column 320 having equal thicknesses on the second substrate 200.

In the present embodiment, the step S120A comprises steps as follows.

A step S121A comprising: providing a second substrate 200.

A step S122A comprising: forming a spacer material layer 3000 on the second substrate 200, as shown in FIG. 7C.

Material of the spacer material layer 3000 comprises but is not limited to one or more of nitrogen oxide (NOx), silicon oxide (SiOx), and silicon nitride (SiNx), and can be formed by insulative and transparent photoresist.

A step S123A comprising: providing a mask 400, exposing and developing the spacer material layer 3000, and forming a spacer layer 300 on the second substrate 200. The spacer layer 300 comprises a main spacer column 310 and a sub-spacer column 320 having equal thicknesses, as shown in FIG. 7D.

It can be understood that because the thicknesses of the manufactured main spacer column 310 and sub-spacer column 320 are equal, only spacer columns with one height need to be manufactured, such that the spacer columns can be manufactured under the same mask 400 without using another mask 400 for manufacturing spacer column of different thicknesses, which simplifies manufacturing processes of the display panel. At the same time, different from the conventional technologies wherein it is required to use half-tone masks 400 or grayscale masks having different transmittances to manufacture the main spacer column 310 and the sub-spacer column 320 with unequal thicknesses, in the present embodiment, the main spacer column 310 and the sub-spacer column 320 can be manufactured by a general mask, which effectively lowers a manufacturing cost of the display panel.

Continuing from the above, a step S200A comprises: aligning the first substrate 100 with the second substrate 200, such that the sub-spacer column 320 corresponds to the aperture 20, as shown in FIG. 2.

Specifically, the main spacer column 310 is located between the first color resist 121 and the second substrate 200. An end of the main spacer column 310 is located on the second substrate 200, and another end of the main spacer column 310 abuts the first color resist. The sub-spacer column 320 is located between the aperture 20 of the second color resist 122 and the third color resist 123 and the second substrate 200. An end of the sub-spacer column 320 is located on the second substrate 200, and another end of the sub-spacer column 320 and the aperture 20 are disposed at an interval.

Continuing from the above, a step S300A comprises: forming a liquid crystal layer between the first substrate 100 and the second substrate 200.

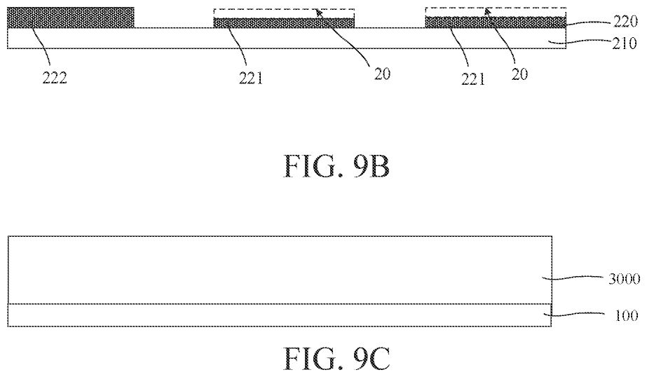

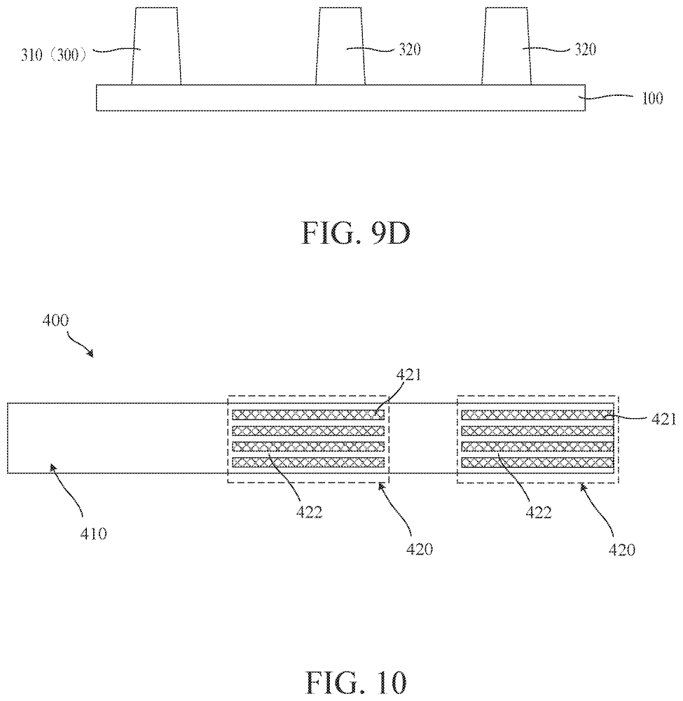

With reference to FIGS. 9A to 9D, in an embodiment, the step S100 comprises steps as follows.

A step S110B comprising: providing a second substrate 200 and defining an aperture 20 in the second substrate 200.

In the present embodiment, the step S110B comprises steps as follows.

A step S111B comprising: providing a second underlay 210.

A step S112B comprising: forming a black matrix material layer 2200 on the second underlay 210, as shown in FIG. 9A.

Furthermore, the step S112B comprises: coating black matrix material on the second underlay 210. It should be explained that the black matrix material employed in the present embodiment and a method for coating the black matrix material layer 2200 are the same the conventional technology, which is not described here repeatedly. The step S112B further comprises curing the black matrix material and forming the black matrix material layer 2200.

With reference to FIG. 10, the step S113B comprises: providing a mask 400, and exposing and developing the black matrix material layer 2200 to form a black matrix 220 comprising the aperture 20. The mask 400 comprises a main light transmission region 410 disposed to correspond to the black matrix material layer 2200 and a sub-light transmission region 420 located adjacent to the main light transmission region 410. The sub-light transmission region 420 comprises a plurality of light shielding frames 421 disposed at intervals. A light transmission slit 422 is formed between adjacent two of the light shielding frames 421. Preferably, shapes of the main light transmission region 410 and the light shielding frames 421 are rectangular. It can be understood that the present embodiment can adjust an interference degree of light irradiating the sub-light transmission region 420 by adjusting a width and a number of the slits 422 in the sub-light transmission region 420 and an interval between adjacent two of the slits 422 to control an exposure degree of a position of the black matrix material layer 2200 corresponding to the sub-light transmission region 420.

The present embodiment makes a thickness of a portion of the exposed black matrix material layer 2200 corresponding to the main light transmission region 410 greater than a thickness of a portion of the black matrix material layer 2200 corresponding to the sub-light transmission region 420 by setting an exposure intensity of the sub-light transmission region 420 to be less than an exposure intensity of the main light transmission region 410. By utilizing a leveling property of the black matrix material, an aperture 20 with high surface flatness can be formed in the portion of the black matrix material layer 2200 corresponding to the sub-light transmission region 420.

Furthermore, the black matrix 220 comprises a plurality of black modules. The black modules comprise a first black module 221 and a second black module 222. The aperture 20 is defined in the first black module 221 and extends to a periphery of the first black module 221. The thickness of each portion of the first black module 221 is equal, as shown in FIG. 9B.

Continuing from the above, a step S120B: providing a first substrate 100, and forming a main spacer column 310 and a sub-spacer column 320 with equal thicknesses on the first substrate 100.

In the present embodiment, the step S120B comprises steps as follows:

A step S121B comprising: providing a first substrate 100.

A step S122B comprising: forming a spacer material layer 3000 on the first substrate 100, as shown in FIG. 9C.

Material of the spacer material layer 3000 comprises but is not limited to one or more of nitrogen oxide (NOx), silicon oxide (SiOx), and silicon nitride (SiNx), and can be formed by insulative and transparent photoresist.

A step S123B comprises: providing a mask 400, exposing and developing the spacer material layer 3000, and forming a spacer layer 300 on the first substrate 100. The spacer layer 300 comprises a main spacer column 310 and a sub-spacer column 320 with equal thicknesses, as shown in FIG. 9D.

It can be understood that because the thicknesses of the manufactured main spacer column 310 and sub-spacer column 320 are equal, only spacer columns with one height need to be manufactured, such that the spacer columns can be manufactured under the same mask 400 without using another mask 400 for manufacturing spacer column of different thicknesses, which simplifies manufacturing processes of the display panel. At the same time, different from the conventional technologies wherein it is required to use half-tone masks 400 or grayscale masks having different transmittances to manufacture the main spacer column 310 and the sub-spacer column 320 with unequal thicknesses, in the present embodiment, the main spacer column 310 and the sub-spacer column 320 can be manufactured by a general mask, which effectively lowers a manufacturing cost of the display panel.

Continuing from the above, a step S200B comprises: aligning the first substrate 100 with the second substrate 200, such that the sub-spacer column 320 corresponds to the aperture 20, as shown in FIG. 4.

Specifically, the main spacer column 310 is located between the second black module 222 and the first substrate 100. An end of the main spacer column 310 is located on the first substrate 100, and another end of the main spacer column 310 abuts the second black module 222. The sub-spacer column 320 is located between the first black module 221 and the first substrate 100. An end of the sub-spacer column 320 is located on the first substrate 100, and a gap is defined between another end of the sub-spacer column 320 and the first black module 221.

Continuing from the above, a step S300A comprises: forming a liquid crystal layer between the first substrate 100 and the second substrate 200.

It should be explained that both the first underlay 110 and the second underlay 210 can comprise a rigid underlay or a flexible underlay. When both the first underlay 110 and the second underlay 210 are rigid underlays, material of the first underlay 110 and the second underlay 210 comprises but is not limited to metal or glass. When both the first underlay 110 and the second underlay 210 are flexible underlays, material of the first underlay 110 and the second underlay 210 comprises but is not limited to polyimide. The present embodiment has no limit to material of the first underlay 110 and the second underlay 210.

The present embodiment further provides a display device comprising any one of the display panels of the above embodiments.

The display panel has been described in detail in the above embodiments and will not be described here repeatedly.

In specific applications, the display device can be a display screen of a device such as smart cell phone, tablet, notebook, smart bracelet, smart watch, smart glasses, smart helmet, desktop, smart television, or digital camera, and can even be applied to an electronic device with a flexible display screen.

As described above, the present application discloses a display panel, a manufacturing method thereof, and a display device. The display panel comprises a first substrate and a second substrate disposed oppositely, and a liquid crystal layer and a spacer layer disposed between the first substrate and the second substrate. The spacer layer comprises a main spacer column disposed between the first substrate and the second substrate and a sub-spacer column. A thickness of the main spacer column is equal to a thickness of the sub-spacer column. An aperture is defined in the first substrate or the second substrate and corresponds to the sub-spacer column. The thickness of the main spacer column provided by the present application is equal to the thickness of the sub-spacer column, and therefore only spacer columns with one height need to be manufactured. Namely, when the main spacer column and the sub-spacer column are manufactured, a mask process only needs to be implemented once, which further lowers a manufacturing cost of the display panel.

In the above-mentioned embodiments, the descriptions of the various embodiments are focused. For the details of the embodiments not described, reference may be made to the related descriptions of the other embodiments.

It can be understood that for a person of ordinary skill in the art, equivalent replacements or changes can be made according to the technical solution of the present application and its inventive concept, and all these changes or replacements should belong to the scope of protection of the appended claims of the present application.

What is claimed is:

1. A display panel, comprising a first substrate and second substrate disposed oppositely, and a liquid crystal layer and a spacer layer disposed between the first substrate and the second substrate, wherein the spacer layer comprises a main spacer column and a sub-spacer column disposed between the first substrate and the second substrate;
wherein a thickness of the main spacer column is equal to a thickness of the sub-spacer column; an aperture is defined in the first substrate and corresponds to the sub-spacer column, a distance between the sub-spacer column and the first substrate is greater than a distance between the main spacer column and the first substrate; or the aperture is defined in the second substrate and corresponds to the sub-spacer column, a distance between the sub-spacer column and the second substrate is greater than a distance between the main spacer column and the second substrate.

2. The display panel according to claim 1, wherein the main spacer column and the sub-spacer column are disposed on the second substrate; and
the first substrate comprises a first underlay and a color resist layer disposed on a side of the first underlay near the second substrate, the aperture is defined in a portion of the color resist layer corresponding to the sub-spacer column, and the sub-spacer column is disposed in the aperture.

3. The display panel according to claim 2, wherein the display panel further comprises a display region and a non-display region adjacent to the display region, wherein adjacent ones of the apertures are disposed at intervals and are located in the non-display region.

4. The display panel according to claim 2, wherein the color resist layer at least comprises a first color resist, a second color resist, and a third color resist, a thickness of the second color resist is less than a thickness of the first color resist, and a thickness of the third color resist is less than the thickness of the first color resist; and
wherein the main spacer column is disposed to correspond to the first color resist, the sub-spacer column is disposed to correspond to the second color resist and the third color resist, and the aperture is disposed on the second color resist and/or the third color resist.

5. The display panel according to claim 4, wherein an orthographic projection of the first color resist on the second substrate covers an orthographic projection of the main spacer column on the second substrate, an orthographic projection of the second color resist and the third color resist on the second substrate covers an orthographic projection of the sub-spacer column on the second substrate, and the aperture is defined in the second color resist and/or the third color resist.

6. The display panel according to claim 1, wherein the main spacer column and the sub-spacer column are located on the first substrate, the second substrate comprises a second underlay and a black matrix located on a side of the second underlay near the first substrate, and the aperture is disposed on the black matrix and corresponds to the sub-spacer column.

7. The display panel according to claim 6, wherein the black matrix comprises a plurality of black modules, the black modules comprise a first black module corresponding to the sub-spacer column, the aperture is defined in the first black module and extends to a periphery of the first black module, and a thickness of each portion of the first black module is the same.

8. The display panel according to claim 6, wherein the first substrate comprises a metal layer; and
wherein an orthographic projection of the metal layer on the first substrate covers an orthographic projection of the aperture on the first substrate.

9. The display panel according to claim 8, wherein the orthographic projection of the metal layer on the first substrate covers an orthographic projection of the main spacer column on the first substrate, and the orthographic projection of the metal layer on the first substrate covers an orthographic projection of the sub-spacer column on the first substrate.

10. A display panel manufacturing method, comprising steps as follows:
providing a first substrate and a second substrate and defining an aperture in one of the first substrate or the second substrate, wherein a main spacer column and a sub-spacer column with equal thicknesses are formed on the other of the first substrate or the second substrate;
aligning the first substrate with the second substrate, such that the sub-spacer column corresponds to the aperture; and
forming a liquid crystal layer between the first substrate and the second substrate.

11. The display panel manufacturing method according to claim 10, wherein the step of providing the first substrate and the second substrate and defining the aperture in one of the first substrate or the second substrate comprises: providing the first substrate and defining the aperture in the first substrate;
the step of providing the first substrate and defining the aperture in the first substrate comprises:
providing a first underlay;
forming a color resist material layer on the first underlay; and
providing a mask, and exposing and developing the color resist material layer to form a color resist layer comprising the aperture, wherein the mask comprises a main light transmission region disposed to correspond to the color resist material layer and a sub-light transmission region located adjacent to the main light transmission region, the sub-light transmission region comprises a plurality of light shielding frames disposed at intervals, and a slit for light transmission is formed between adjacent two of the light shielding frames.

12. The display panel manufacturing method according to claim 10, wherein the step of providing the first substrate and the second substrate and defining the aperture in one of the first substrate or the second substrate comprises: providing the second substrate and defining the aperture in the second substrate;
the step of providing the second substrate and defining the aperture in the second substrate comprises:
providing a second underlay;
forming a black matrix material layer on the second underlay; and
providing a mask, and exposing and developing the black matrix material layer to form a black matrix comprising the aperture, wherein the mask comprises a main light transmission region disposed to correspond to the black matrix material layer and a sub-light transmission region located adjacent to the main light transmission region, the sub-light transmission region comprises a plurality of light shielding frames disposed at intervals, and a slit for light transmission is formed between adjacent two of the light shielding frames.

13. A display device, comprising a display panel, and the display panel comprising a first substrate and second substrate disposed oppositely and a liquid crystal layer and a spacer layer disposed between the first substrate and the second substrate, wherein the spacer layer comprises a main spacer column and a sub-spacer column disposed between the first substrate and the second substrate;
wherein a thickness of the main spacer column is equal to a thickness of the sub-spacer column; an aperture is defined in the first substrate and correspond to the sub-spacer column, a distance between the sub-spacer column and the first substrate is greater than a distance between the main spacer column and the first substrate, or the aperture is defined in the second substrate and correspond to the sub-spacer column, a distance between the sub-spacer column and the second substrate is greater than a distance between the main spacer column and the second substrate.

14. The display device according to claim 13, wherein the main spacer column and the sub-spacer column are disposed on the second substrate; and
the first substrate comprises a first underlay and a color resist layer disposed on a side of the first underlay near the second substrate, the aperture is defined in a portion of the color resist layer corresponding to the sub-spacer column, and the sub-spacer column is disposed in the aperture.

15. The display device according to claim 14, wherein the display panel further comprises a display region and a non-display region adjacent to the display region, wherein adjacent ones of the apertures are disposed at intervals and are located in the non-display region.

16. The display device according to claim 14, wherein the color resist layer at least comprises a first color resist, a second color resist, and a third color resist, a thickness of the second color resist is less than a thickness of the first color resist, and a thickness of the third color resist is less than the thickness of the first color resist; and
wherein the main spacer column is disposed to correspond to the first color resist, the sub-spacer column is disposed to correspond to the second color resist and the third color resist, and the aperture is disposed on the second color resist and/or the third color resist.

17. The display device according to claim 16, wherein an orthographic projection of the first color resist on the second substrate covers an orthographic projection of the main spacer column on the second substrate, an orthographic projection of the second color resist and the third color resist on the second substrate covers an orthographic projection of the sub-spacer column on the second substrate, and the aperture is defined in the second color resist and/or the third color resist.

18. The display device according to claim 13, wherein the main spacer column and the sub-spacer column are located on the first substrate, the second substrate comprises a second underlay and a black matrix located on a side of the second underlay near the first substrate, and the aperture is disposed on the black matrix and corresponds to the sub-spacer column.

19. The display device according to claim 18, wherein the black matrix comprises a plurality of black modules, the black modules comprise a first black module corresponding to the sub-spacer column, the aperture is defined in the first black module and extends to a periphery of the first black module, and a thickness of each portion of the first black module is the same.

20. The display device according to claim 18, wherein the first substrate comprises a metal layer; and
wherein an orthographic projection of the metal layer on the first substrate covers an orthographic projection of the aperture on the first substrate.
